(19) United States
(12) Patent Application Publication
(10) Pub. No.: US 2018/0010875 A1
(43) Pub. Date: Jan. 11, 2018

(54) SWIVELING GUN REST FOR HUNTING BLIND

(71) Applicant: Stanley Howard Chism, Odessa, TX (US)

(72) Inventor: Stanley Howard Chism, Odessa, TX (US)

(21) Appl. No.: 15/204,911

(22) Filed: Jul. 7, 2016

(51) Int. Cl. F41A 23/02; A01M 31/02; F16M 11/08; F16M 13/02

(52) U.S. Cl. CPC F41A 23/02; F16M 13/022; A01M 31/025; F16M 11/08

(57) ABSTRACT

A swiveling gun rest is disclosed, comprising a mounting unit for mounting to a surface of a hunting blind, and a swiveling support unit for supporting a gun and a body of a person using the gun. The mounting unit may include a mast having a foot able to contact a floor of the hunting blind. A swivel joint accommodates swivel of the support unit about a vertical axis, so as to be able to fire through windows of the hunting blind. The foot may accommodate the combined weights of the gun rest, gun, and a portion of the body weight of the person. The swivel joint may comprise a plurality of sockets fixed to the mounting unit and an equal number of fingers fixed to the support unit, the fingers configured to occupy the sockets. The support unit may comprise a frame and a cushion atop the frame.

### FIELD OF THE INVENTION

The present invention relates to supports, and more particularly to a swiveling support for supporting an elongated rifle or the like in a horizontal orientation.

### BACKGROUND OF THE INVENTION

Hunters frequently avail themselves of hunting blinds when hunting game. A hunting blind is a small shelter, typically built rigid and fixed in configuration. The hunting blind serves to shelter a hunter and conceal the hunter from game animals. A hunting blind has windows through which projectiles are fired.

Hunting can be difficult in that a weapon must be held in carefully controlled position until the moment of firing. Any deviation from the controlled position can cause the hunter to miss his or her target. Weapons used by hunters can include long rifles, which are difficult to hold steady merely by manual grasp.

Gun rests have been provided to address this problem. A gun rest may be fixed to a suitable structural portion of the hunting blind, such as a vertical wall. However, construction of hunting blinds typically does not anticipate any specific type of gun rest. Hence it falls to the gun rest to conform to and accommodate the hunting blind. There exists a need for a gun rest which is well adapted for mounting to a hunting blind, accommodating a hunter's weight and preferred body position, and is suitable for use with diverse styles of guns.

### SUMMARY OF THE INVENTION

The present invention addresses the above stated situation by providing a gun rest which readily mounts to a hunting blind, provides a flat support table unencumbered by complicated construction or by projections, thereby accommodating diverse placement of a gun and different body positions when leaning on the gun support, and which accommodates different gun styles and configurations.

To these ends, the gun rest includes a mounting unit for mounting to a wall of the hunting blind, and a support unit for supporting a gun and a body of a person using the gun. A swivel joint accommodates swivel of the support unit relative to the mounting unit about a vertical axis, thereby enabling the gun to fire through any one of the windows of the hunting blind. The mounting unit includes a foot located to be able to contact a floor of the hunting blind, thereby reducing loads imposed on mounting bolts securing the mounting unit to the wall of the hunting blind. The swivel joint may comprise an upper socket and lower socket on the mounting unit, and corresponding fingers on the swiveling support unit.

The support unit comprises a support member including a flat planar horizontal support surface, enabling a variety of gun supports to be laid thereon, with the hunter supporting some of his or her upper body on the support unit as well as the gun.

It is an object of the invention to provide improved elements and arrangements thereof by apparatus for the purposes described which is inexpensive, dependable, and fully effective in accomplishing its intended purposes.

This and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a swiveling gun rest mounted in a hunting blind, according to at least one aspect of the invention;

FIG. 2 is an exploded view of two major components of the swiveling gun rest of FIG. 1; and

FIG. 3 is a perspective exterior view of the hunting blind shown in FIG. 1.

### DETAILED DESCRIPTION

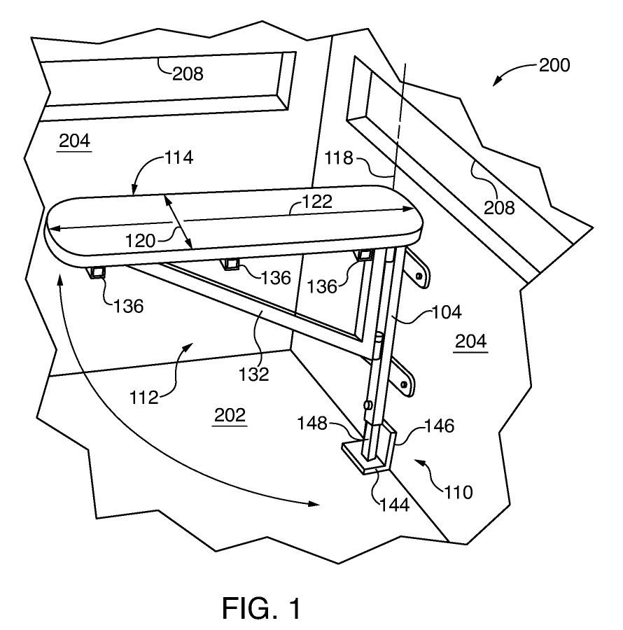

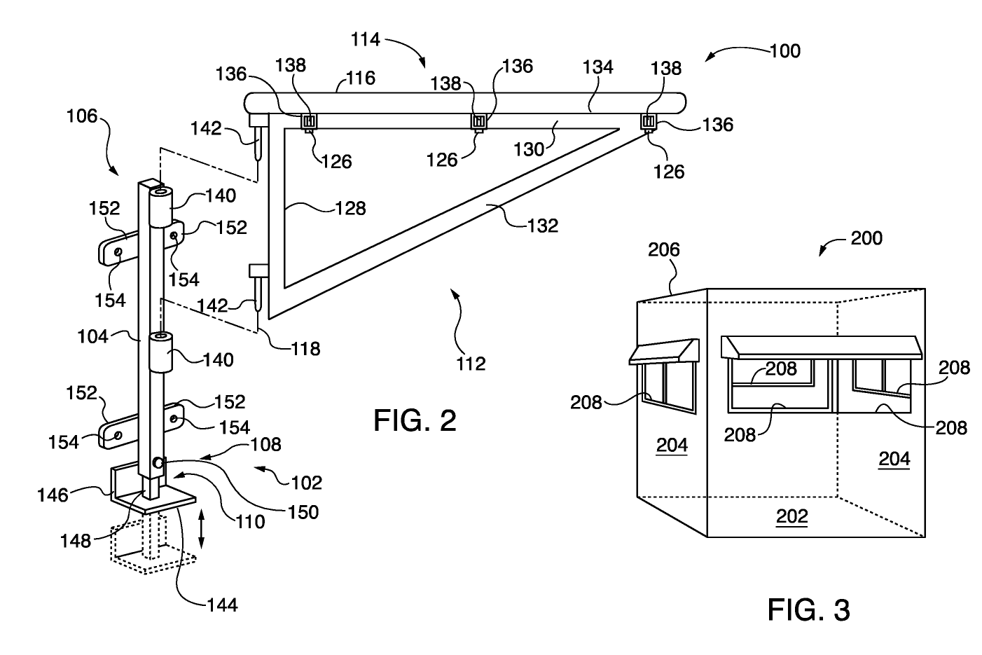

Referring first to FIGS. 1 and 2, according to at least one aspect of the invention, there is shown a swiveling gun rest 100 comprising a mounting unit 102 configured to be mounted on a surface (e.g., a wall 204) of a hunting blind 200 or the like. Mounting unit 102 comprises a mast 104 including an upper end 106, a lower end 108, and a bracket member 110 attached to the lower end 108. Bracket member 110 includes an adjuster configured to raise and lower bracket member 110 relative to mast 104. Swiveling gun rest 100 also comprises a support unit 112 for supporting a gun (not shown) and a body of a person (not shown) using the gun. Support unit 112 comprises a support member 114 including a flat planar horizontal support surface 116. Swiveling gun rest 100 further comprises at least one swivel joint configured to swivel support unit 112 relative to mounting unit 102 about a vertical axis 118 when mounting unit 102 is on the surface of hunting blind 200.

The adjuster will be described hereinafter. Axis 118 is an axis of rotation of support unit 112 as the latter swivels on mounting unit 102. Swivel joints will be further explained hereinafter.

It should be noted at this point that orientational terms such as upper and lower refer to the subject drawing as viewed by an observer. The drawing figures depict their subject matter in orientations of normal use, which could obviously change with changes in body posture and position. Therefore, orientational terms must be understood to provide semantic basis for purposes of description only, and do not imply that their subject matter can be used only in one position. For example, axis 118 is vertical in an orientation of normal use illustrated in FIGS. 1 and 2.

Support member 114 is used to support a gun, cushions or other structure holding the gun in an operable position, and weight of the upper body of a person using the gun. To comfortably and stably support these items, support member 114 comprises a yielding material, such as cotton batting or an open cell or closed cell synthetic resinous foam. A fabric or other cover (not shown) may be provided to protect the yielding material from contamination. Support member 114 has a length 122 (FIG. 1) between two feet and four feet, and a width 120 between six and fifteen inches.

Support unit 102 comprises a frame 124. Support member 114 is coupled to frame 124. Support member 114 is removably mounted to frame 124 of support unit 112. Support unit 112 comprises a plurality of fasteners 126 (FIG. 2) removably securing support member 114 to frame 124 of support unit 112. Referring principally to FIG. 2, frame 124 of support unit 112 comprises a vertical first member 128 proximate mast 104 of mounting unit 102, a horizontal second member 130 fixed to vertical first member 128, and a spanning member 132 fixed to vertical first member 128 and to horizontal second member 130. Horizontal second member 130 of frame 124 of support unit 112 comprises a frame upper surface 134 and a plurality of laterally projecting tabs 136 having tab upper surfaces 138 coplanar with frame upper surface 134. Vertical first member 128 of frame 124 has a height between fifteen inches and twenty-five inches. Horizontal second member 130 of frame 124 has a length between twenty-five and forty inches. In FIG. 2, the height is vertical and the length is horizontal.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” or higher-numbered item.

In the example of swiveling gun rest 100 illustrated in FIGS. 1 and 2, the swivel joint comprises at least one socket 140 on one of mounting unit 102 and support unit 112, and at least one finger 142 rigidly coupled to the other one of mounting unit 102 and support unit 112. Finger 142 is dimensioned and configured to slidably penetrate socket 140 in close cooperation therewith. In the example of swiveling gun rest 100 illustrated in FIGS. 1 and 2, the swivel joint comprises a first socket 140 on one of mounting unit 102 and support unit 112, a second socket 140 axially aligned with the first socket 140 on the one of mounting unit 102 and support unit 112, a first finger 142 on the other one of mounting unit 102 and support unit 112, and a second finger 142 axially aligned with the second socket 140 on the other one of mounting unit 102 and support unit 112. The first socket 140 and first finger 142 are proximate upper end 106 of mast 104, and the second socket 140 and second finger 142 are proximate lower end 108 of mast 104. Locating one socket 140 and associated finger 142 at each end of 128 results in the most stable support arrangement for support unit 112, in that torques applied to potentially one swivel joint are minimized by distribution over two such joints. Spreading the two joints apart vertically further reduces maximum loading at any one point along mast 104.

Also, using sockets 140 and associated fingers 142 enables ready assembly of swiveling gun rest 100 after mounting unit 102 is fixed to hunting blind 200. Additionally, support unit 112 may be readily removed from hunting blind 200 to dissuade likelihood of theft or vandalism.

Foot 110 of mounting unit 102 comprises a horizontal surface 144 engaging floor 202 of hunting blind 200 and a vertical surface 146 engaging a vertical wall 204 of hunting blind 200 when horizontal surface 144 engages floor 202. Mounting unit 102 comprises an adjuster selectively and adjustably coupling foot 110 to mast 104, wherein direction of adjustability is the same as that of axis 118 of rotation of the at least one swivel joint. In the example of FIGS. 1 and 2, the adjuster comprises telescoping fit of mast 104 with a cooperating tube 148 of foot 110, and a setscrew 150 which threads to mast 104. Setscrew 150 clamps mast 104 and cooperating tube 148 together at any selected mutual position. Adjustment of foot 110 can reduce some of the weight that would otherwise be imposed on fasteners used to affix mounting unit 102 to vertical wall 204.

Mast 104 of mounting unit 102 comprises a plurality of laterally projecting tabs 152 each bearing at least one hole 154 for receiving a fastener (not shown) to accommodate mounting mounting unit 112 to vertical wall 204 of hunting blind 200.

The invention may be thought of either as swiveling gun rest 100, or alternatively, as hunting blind 200 incorporating swiveling gun rest 100.

Referring also to FIG. 3, hunting blind 200 incorporating swiveling gun rest 100 may comprise a shelter structure including a roof 206, and at least one vertical wall 204 having at least one window 208, and swiveling gun rest 100 for hunting blind 200. Swiveling gun rest 100 comprises mounting unit 102 for mounting to the at least one vertical wall 204 of hunting blind 200. Mounting unit 102 comprises mast 104 including upper end 106, lower end 108, and foot 110 at lower end 108. Foot 110 is located to be able to contact an upwardly facing ground surface of hunting blind 200. Swiveling gun rest 100 further comprises support unit 112 for supporting a gun (not shown) and a body of a person (not shown) using the gun, support unit 112 comprising support member 114 including flat planar horizontal support surface 116. Swiveling gun rest 100 further comprises at least one swivel joint accommodating swivel of support unit 112 relative to mounting unit 102 about vertical axis 118. Flat planar horizontal support surface 116 is aligned with a window 208 such that a gun supported on flat planar horizontal support surface 116 fires through window 208. Preferably, windows 208 are distributed about the perimeter of hunting blind 200 to provide three hundred sixty degrees of aiming coverage of the environs of hunting blind 200.

In the example of FIGS. 1 and 3, hunting blind 200 incorporating swiveling gun rest 100 comprises a shelter structure including roof 206, floor 202, and four vertical walls 204 between roof 206 and floor 202. Each one of vertical walls 204 has a window 208. Hunting blind 200 comprises swiveling gun rest 100 comprising mounting unit 102 for mounting to one vertical wall 204 of hunting blind 200. Mounting unit 102 comprises mast 104 including upper end 106, lower end 108, and foot 110 at lower end 108. Foot 110 is located to be able to contact floor 202 of hunting blind 200. Hunting blind 200 comprises support unit 112 for supporting a gun (not shown) and a body of a person (not shown) using the gun, support unit 112 comprising support member 114 including flat planar horizontal support surface 116 and at least one swivel joint accommodating swivel of support unit 112 relative to mounting unit 102 about vertical axis 118. Flat planar horizontal support surface 116 is aligned with each one of windows 208 such that a gun supported on flat planar horizontal support 116 surface fires through any one of windows 208.

Although presented thus far as having four vertical walls 204, hunting blind 200 may have fewer or more vertical walls 204. For example, hunting blind 200 may be open at one end where it is anticipated that hunting blind 200 will be pushed against a bluff or other vertical environmental surface, which may render at least one of the four vertical walls unnecessary. Alternatively, a single curved wall (not shown) may replace the four discrete vertical walls 204. Floor 202 of hunting blind 200 may be eliminated if ground conditions are deemed sufficient as not to warrant floor 202. Therefore, reference to an “upwardly facing ground surface”, where the term is applied to hunting blind 200, will be understood to encompass both floor 202 and also natural ground surfaces where floor 202 is absent.

In addition to hunting blinds, swiveling gun rest 100 may be mounted on or incorporated into other structures (none shown), such as houses, garages, sheds, carports, fences, shooting range structures, fences, docks, piers, vehicles, boats, and other structures, both stationary and mobile, presenting a generally vertical surface for mounting.

Although the invention has been described in terms of certain components being referred to in either the singular or the plural, other arrangements are possible. For example, hunting blind has been presented as comprising four walls. It would be possible to have a single curved wall instead. Alternatively, in a hunting blind adapted to be pushed against a bluff or other natural vertical surface, one or more walls may be omitted, as may be floor.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A swiveling gun rest, comprising:
a mounting unit configured to be mounted on a surface of a hunting blind or the like, the mounting unit comprising a mast including
an upper end, a lower end, and a bracket member attached to the lower end, the bracket member including an adjuster configured to raise and lower the bracket member relative to the mast;
a support unit for supporting a gun and a body of a person using the gun, the support unit comprising a support member including a flat planar horizontal support surface; and
at least one swivel joint configured to swivel the support unit relative to the mounting unit about a vertical axis when the mounting unit is on the surface of the hunting blind.

2. The swiveling gun rest of claim 1, wherein the support member comprises a yielding material.

3. The swiveling gun rest of claim 1, wherein the support member has a length between two feet and four feet, and a width between six and fifteen inches.

4. The swiveling gun rest of claim 1, wherein the support unit comprises a frame, and the support member is coupled to the frame.

5. The swiveling gun rest of claim 4, wherein the support member is removably mounted to the frame of the support unit, the support unit comprising a plurality of fasteners removably securing the support member to the frame of the support unit.

6. The swiveling gun rest of claim 4, wherein the frame of the support unit comprises a vertical first member proximate the mast of the mounting unit, a horizontal second member fixed to the vertical first member, and a spanning member fixed to the vertical first member and to the horizontal second member.

7. The swiveling gun rest of claim 6, wherein the horizontal second member of the frame of the support unit comprises a frame upper surface and a plurality of laterally projecting tabs having tab upper surfaces coplanar with the frame upper surface.

8. The swiveling gun rest of claim 6, wherein the vertical first member of the frame has a height between fifteen inches and twenty-five inches, and the horizontal second member of the frame has a length between twenty-five and forty inches.

9. The swiveling gun rest of claim 1, wherein the swivel joint comprises at least one socket on one of the mounting unit and the support unit, and at least one finger rigidly coupled to the other one of the mounting unit and the support unit, wherein the finger is dimensioned and configured to slidably penetrate the socket in close cooperation therewith.

10. The swiveling gun rest of claim 1, wherein the swivel joint comprises a first socket on one of the mounting unit and the support unit, a second socket axially aligned with the first socket on the one of the mounting unit and the support unit, a first finger on the other one of the mounting unit and the support unit, and a second finger axially aligned with the second socket on the other one of the mounting unit and the support unit, wherein the first socket and the first finger are proximate the upper end of the mast, and the second socket and the second finger are proximate the lower end of the mast.

11. The swiveling gun rest of claim 1, wherein the foot of the mounting unit comprises a horizontal surface engaging a floor of the hunting blind and a vertical surface engaging a vertical wall of the hunting blind when the horizontal surface engages the floor.

12. The swiveling gun rest of claim 1, wherein the mounting unit comprises an adjuster selectively and adjustably coupling the foot to the mast, wherein direction of adjustability is the same as that of an axis of rotation of the at least one swivel joint.

13. The swiveling gun rest of claim 1, wherein the mast of the mounting unit comprises a plurality of laterally projecting tabs each bearing at least one hole for receiving a fastener to accommodate mounting the mounting unit to the vertical wall of the hunting blind.

14. A hunting blind incorporating a swiveling gun rest, comprising:
a shelter structure including a roof, and at least one vertical wall having at least one window; and
a swiveling gun rest for a hunting blind, comprising:
a mounting unit for mounting to the at least one vertical wall of the hunting blind, the mounting unit comprising a mast including an upper end, a lower end, and a foot at the lower end, wherein the foot is located to be able to contact an upwardly facing ground surface of the hunting blind;
a support unit for supporting a gun and a body of a person using the gun, the support unit comprising a support member including a flat planar horizontal support surface; and
at least one swivel joint accommodating swivel of the support unit relative to the mounting unit about a vertical axis, wherein
the flat planar horizontal support surface is aligned with the window such that a gun supported on the flat planar horizontal support surface fires through the window.

15. A hunting blind incorporating a swiveling gun rest, comprising:
a shelter structure including a roof, a floor, and four vertical walls between the roof and the floor, each one of the vertical walls having a window; and
a swiveling gun rest for the hunting blind, comprising:
a mounting unit for mounting to one vertical wall of the hunting blind, the mounting unit comprising a mast including an upper end, a lower end, and a foot at the lower end, wherein the foot is located to be able to contact the floor of the hunting blind;
a support unit for supporting a gun and a body of a person using the gun, the support unit comprising a support member including a flat planar horizontal support surface; and
at least one swivel joint accommodating swivel of the support unit relative to the mounting unit about a vertical axis, wherein
the flat planar horizontal support surface is aligned with each one of the windows such that a gun supported on the flat planar horizontal support surface fires through any one of the windows.
